(19) United States
(12) Patent Application Publication
(10) Pub. No.: US 2025/0136735 A1
(43) Pub. Date: May 1, 2025

(54) POLYMER, TACKIFIER AND PREPARATION METHOD THEREFOR, AND DRILLING FLUID

(71) Applicants: CHINA PETROLEUM & CHEMICAL CORPORATION, Beijing (CN); SINOPEC PETROLEUM ENGINEERING TECHNOLOGY RESEARCH INSTITUTE CO., LTD, Beijing (CN)

(72) Inventors: Daqi LI, Beijing (CN); Yang XUAN, Beijing (CN); Junbin JIN, Beijing (CN); Lin WANG, Beijing (CN); Xiaohua YANG, Beijing (CN); Sheng LI, Beijing (CN); Dong ZHANG, Beijing (CN); Ziqiao HU, Beijing (CN); Zhoujun LI, Beijing (CN)

(21) Appl. No.: 18/689,516

(22) PCT Filed: Jul. 20, 2022
(86) PCT No.: PCT/CN2022/106839

§ 371 Date: Mar. 6, 2024

(30) Foreign Application Priority Data
Sep. 6, 2021 (CN) 202111038721.8

(51) Int. Cl. C08F 220/56; C08F 220/28; C08F 220/34; C08F 220/38; C09K 8/035; C09K 8/12

(52) U.S. Cl. CPC C08F 220/56; C08F 220/283; C08F 220/34; C08F 220/38; C09K 8/035; C09K 8/12

(57) ABSTRACT

Disclosed are a polymer, a tackifier, a preparation method therefor and a drilling fluid. The polymer contains a structural unit represented by a formula (1), a structural unit represented by a formula (2) and a structural unit represented by a formula (3), wherein R₁, R₂, R₃, R₄, R₅, R₆, R₇ and R₈ are each independently hydrogen or C1 to C10 linear or branched alkyl; X is C1 to C10 linear or branched alkylene; Y is a formula (4) or C1 to C10 linear or branched alkylene; and M is hydrogen or an alkali metal, and A₁, A₂ and A₃ are each independently a bond or C1 to C3 linear or branched alkylene. The polymer can still maintain excellent viscosity-increasing performance in a high-temperature and high-calcium environment.

### FIELD OF THE INVENTION

The present disclosure relates to the technical field of oil field drilling fluids, in particular to a polymer, a tackifier and preparation method therefor, and a drilling fluid.

### BACKGROUND OF THE INVENTION

A large quantity of solid phases such as clay and barite in a drilling fluid is one of important factors causing damage to a hydrocarbon reservoir and reduction of productivity, and a solid-free drilling fluid system can effectively prevent damage of the solid phases in the drilling fluid to the reservoir. The solid-free drilling fluid system generally refers to a drilling fluid system without clay and an insoluble solid weighting material, a density of the system can be regulated through soluble salts, and other performance of the system can be achieved by adding a matching treating agent. According to different used soluble salts, the solid-free drilling fluid system can be generally divided into two main categories of an inorganic salt type solid-free drilling fluid and an organic salt type solid-free drilling fluid. Inorganic salts are mainly NaCl, CaCl₂), KCl, NaBr and BaBr₂, phosphates and the like, and organic salts are mainly formates, such as NaCOOH, KCOOH, CsCOOH and the like. Other compatible treating agents are mainly a tackifier, a shear strength improving agent, a fluid loss additive, a lubricating agent, a corrosion inhibitor, a buffering agent and the like.

In tackifiers, a polymer type tackifier is one of common additives of the solid-free drilling fluid and also is a key factor ensuring cuttings suspension and carrying performance of the whole system, polymer molecules in the drilling fluid system are mutually entangled to form a space grid structure, and thus cuttings are carried and suspend to be finally removed out of a well. In the prior art, a polymer tackifier applied to the solid-free drilling fluid system has three main categories, the first category is a natural modified polymer represented by modified starch and modified cellulose, for example, CN102127401A discloses a high-temperature-resistant tackifier for a solid-free drilling fluid, which is mainly composed of starch, guar gum, a basic hydroxide, an epoxide and an alcohols solvent, and capable of resisting a temperature of 150° C. in fresh water and resisting a temperature of 120° C. in brine water; the second category is a water soluble copolymer with acrylamide and 2-acryloylamino-2-methyl propane sulfonic acid as monomers, for example, CN104650827A discloses a tackifier with temperature resisting, viscosity increasing and salt resisting performance for a solid-free drilling fluid, which is formed by polymerization with acrylamide, 2-methyl-2-acryloylaminopropane sulfonic acid, N-vinylcaprolactam and divinyl benzene as monomers and has a good viscosity increasing effect before and after aging for 16 h at 165° C. in water; and the third category is a water-soluble hydrophobic association polymer, for example, CN107235863A discloses a hydrophobic association polymer obtained by polymerization with a benzene ring containing hydrophobic monomer and N-vinyl pyrrolidone, which still has good suspension stability after aging for 16 hours at 150° C. For another example, CN107235862A discloses a polymer tackifier for a solid-free drilling fluid, in which a hydrophobic group containing a benzene ring and a long fluorocarbon chain is introduced into the molecule, a viscosity of a solution is remarkably increased through mutual association of hydrophobic molecules, and the tackifier can resist a temperature reaching up to 150° C.

Existing polymer tackifiers mentioned above are good in temperature resistance (the tackifiers can resist a temperature of 150° C.-165° C.), nevertheless, calcium resistance cannot be ensured.

At present, most of oil fields in China are in the middle and later periods of development, and most of undeveloped geological reserves are gathered in a high temperature formation, which proposes a higher requirement for a solid-free drilling fluid with good reservoir protection performance. In particular, a reservoir formation of an extradeep well in Tarim Basin of China is buried deeply with a depth being generally greater than 6500 m, a bottom hole temperature reaches up to 150° C.-180° C., and a formation water type is calcium-type formation water, a concentration of calcium ions can reach up to 15000 mg/L. Therefore, there is an urgent need for researching and developing a high-molecular polymer with good temperature resistance and excellent calcium resistance to serve as a tackifier for a solid-free drilling fluid so as to ensure the suspension performance in a high-temperature and high-calcium environment.

### SUMMARY OF THE INVENTION

Objectives of the present disclosure are to solve the problem that a solid-free drilling fluid cannot be compatible with the temperature resistance and the calcium resistance in the prior art, and provide a polymer, a tackifier, a preparation method therefor and a drilling fluid, the polymer can still maintain excellent viscosity-increasing performance in a high-temperature and high-calcium environment and is quite suitable for serving as a tackifier for a solid-free drilling fluid.

After a great deal of researches, An inventor of the present disclosure discovers that a structural unit containing a sulfonic acid group and a structural unit containing —C(A₁COOH)(A₂COOH)(A₃COOH) are introduced into a polymer with acrylamide as a skeleton structure, so that the polymer can still maintain excellent viscosity-increasing performance in the high-temperature and high-calcium environment and is quite suitable for serving as the tackifier for the solid-free drilling fluid, and thus the present disclosure is fulfilled.

Therefore, a first aspect of the present disclosure provides a polymer, including a structural unit represented by a formula (1), a structural unit represented by a formula (2) and a structural unit represented by a formula (3),

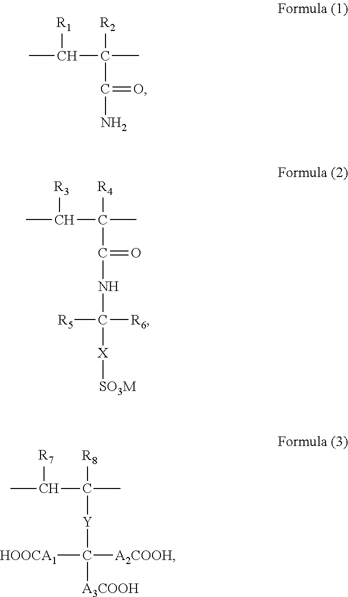

wherein R₁, R₂, R₃, R₄, R₅, R₆, R₇ and R₈ are each independently hydrogen or C1 to C10 linear or branched alkyl;
X is C1 to C10 linear or branched alkylene;
Y is

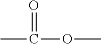

or C1 to C10 linear or branched alkylene;
M is hydrogen or an alkali metal; and
A₁, A₂ and A₃ are each independently a bond or C1 to C3 linear or branched alkylene.

A second aspect of the present disclosure provides a tackifier, including an acrylamide skeleton structure, wherein the tackifier further includes a sulfonic acid group and —C(A₁COOH)(A₂COOH)(A₃COOH), wherein A₁, A₂ and A₃ are each independently a bond or C1 to C3 linear or branched alkylene, the tackifier is added into a solid-free drilling fluid base slurry with a Ca²⁺ concentration of 15000 mg/L at an addition amount of 0.7 wt %, an apparent viscosity after aging for 16 h at 180° C. is 28 mPa·s or above, preferably, 36 mPa·s or above.

A third aspect of the present disclosure provides a preparation method for a tackifier, wherein the method includes: subjecting a monomer represented by a formula (A), a monomer represented by a formula (B) and a monomer represented by a formula (C) to a polymerization reaction in a solvent in the presence of an initiator under a polymerization reaction condition,

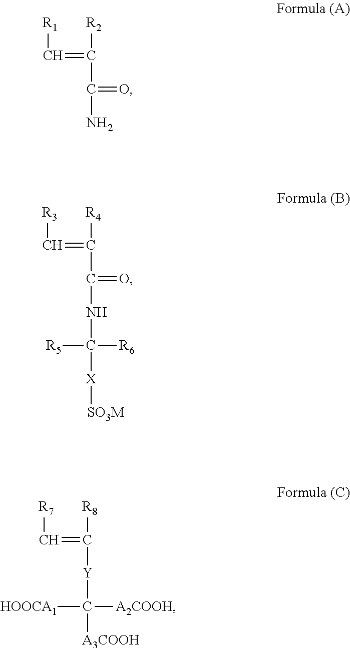

wherein R₁, R₂, R₃, R₄, R₅, R₆, R₇ and R₈ are each independently hydrogen or C1 to C10 linear or branched alkyl;
X is C1 to C10 linear or branched alkylene;
Y is

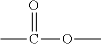

or C1 to C10 linear or branched alkylene;
M is hydrogen or an alkali metal; and
A₁, A₂ and A₃ are each independently a bond or C1 to C3 linear or branched alkylene.

A fourth aspect of the present disclosure provides a drilling fluid, including the polymer mentioned in first aspect or the tackifier mentioned in the second aspect.

The polymer provided by the present disclosure includes the three structural units represented by the formula (1), the formula (2) and the formula (3), so that each of the structural units can not only fully play their own performance features, but also achieve a good synergistic effect, and thus it is guaranteed that when the polymer, as the tackifier, is applied to the solid-free drilling fluid, the polymer still has the excellent viscosity-increasing performance (the apparent viscosity is 28 mPa·s or above) under the conditions of a high temperature (aging for 16 h in 180° C.) and a high calcium ion concentration (15000 mg/L), and is quite suitable for serving as the tackifier for the solid-free drilling fluid.

### BRIEF DESCRIPTION OF THE DRAWING

FIG. 1 is an infrared spectrogram of a polymer A₁ prepared by Example 1.

### DETAILED DESCRIPTION OF THE EMBODIMENTS

End points and any value of a range disclosed herein are not limited to exact ranges or values, these ranges or values are to be understood as including values close to these ranges or values. As for a numerical value range, end point values of each range, each end point value of each range and an independent point value as well as independent point values can be combined to obtain one or more new numerical value ranges, and these numerical value ranges are to be regarded as being specifically disclosed herein.

In the present disclosure, the solid-free drilling fluid refers to a drilling fluid without clay and a weighting agent, the clay is one or more of montmorillonite, illite, kaolinite, sepiolite and the like, and the weighting agent is an insoluble solid weighting agent, including one or more of barite, iron ore powder, galena powder, micro-manganese and the like.

A first aspect of the present disclosure provides a polymer, including a structural unit represented by a formula (1), a structural unit represented by a formula (2) and a structural unit represented by a formula (3),

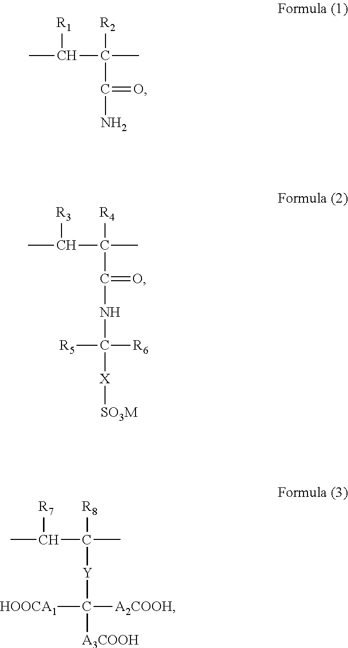

wherein R₁, R₂, R₃, R₄, R₅, R₆, R₇ and R₈ are each independently hydrogen or C1 to C10 linear or branched alkyl;
X is C1 to C10 linear or branched alkylene;
Y is

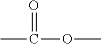

or C1 to C10 linear or branched alkylene;
M is hydrogen or an alkali metal; and
A₁, A₂ and A₃ are each independently a bond or C1 to C3 linear or branched alkylene.

In the present disclosure, an instance of C1 to C10 linear or branched alkyl may be, for example, any one of methyl, ethyl, n-propyl, isopropyl, n-butyl, sec-butyl, isobutyl, tert-butyl, n-amyl, isoamyl, tert-amyl, neo-amyl, n-hexyl, isohexyl, n-heptyl, isoheptyl, 2-methylhexyl, 2-ethylhexyl, 1-methylheptyl, 2-methyl heptyl, n-octyl, isooctyl, n-nonyl, isononyl and 3,5,5-trimethylhexyl.

In the present disclosure, an instance of C1 to C10 linear or branched alkylene may be, for example, any one of methylene, 1,2-ethylidene, n-propylidene, isopropylidene, n-butylidene, isobutylidene, n-amylidene, isoamylidene, n-hexylidene, isohexylidene, n-heptylidene, isoheptylidene, 2-methylhexylidene, 2-ethylhexylidene, 1-methylheptylidene, 2-methylheptylidene, n-octylidene, isooctylidene and n-nonylidene.

In the present disclosure, an instance of the alkali metal may be, for example, any one of Li, Na and K.

In the present disclosure, an instance of C1 to C3 linear or branched alkylene may be, for example, any one of methylene, 1,2-ethylidene, n-propylidene and isopropylidene.

According to the present disclosure, in the formula (1), preferably, R₁ and R₂ are each independently hydrogen or C1 to C6 linear or branched alkyl; more preferably, hydrogen or C1 to C4 linear or branched alkyl; further preferably, hydrogen, methyl or ethyl.

In a particularly preferred implementation of the present disclosure, both R₁ and R₂ in the formula (1) are hydrogen, at the moment, the structural unit represented by the formula (1) may be a structural unit from acrylamide.

According to the present disclosure, in the formula (2), preferably, R₃, R₄, R₅ and R₆ are each independently hydrogen or C1 to C6 linear or branched alkyl; more preferably, hydrogen or C1 to C4 linear or branched alkyl; further preferably, hydrogen, methyl or ethyl.

Besides, in the formula (2), preferably, X is C1 to C6 linear or branched alkylene, more preferably, C1 to C3 linear or branched alkylene, further preferably, methylene or 1,2-ethylidene.

Besides, in the formula (2), preferably, M is hydrogen or sodium.

In a particularly preferred implementation of the present disclosure, both R₃ and R₄ in the formula (2) are hydrogen, both R₅ and R₆ are methyl, X is methylene, and M is hydrogen. At the moment, the structural unit represented by the formula (2) may be a structural unit from 2-acryloylamino-2-methyl propane sulfonic acid.

According to the present disclosure, in the formula (3), preferably, R₇ and R₈ are each independently hydrogen or C1 to C6 linear or branched alkyl; more preferably, hydrogen or C1 to C4 linear or branched alkyl; further preferably, hydrogen, methyl or ethyl.

Besides, in the formula (3), preferably, Y is

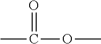

or C1 to C6 linear or branched alkylene, more preferably,

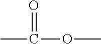

or C1 to C3 linear or branched alkylene, further preferably,

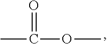

methylene or 1,2-ethylidene.

Besides, in the formula (3), preferably, A₁, A₂ and A₃ are each independently a bond, methylene or 1,2-ethylidene, more preferably, a bond or methylene.

In a particularly preferred implementation of the present disclosure, both R₇ and R& in the formula (3) are hydrogen, Y is

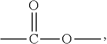

both A₁ and A₂ are methylene, A₃ is a bond, at the moment, the structural unit represented by the formula (3) may be a structural unit from 2-acryloyloxy-1,2,3-tricarboxylicpropane.

According to the present disclosure, in the polymer, a molar ratio of the structural unit represented by the formula (1) to the structural unit represented by the formula (2) to the structural unit represented by the formula (3) may change within a large range, for example, 10-80:10-60:1, preferably, 30-50:20-40:1. By limiting the molar ratio of the above three structural units within the above range, temperature resistance and calcium resistance of the polymer can be further improved when the polymer, as a tackifier, is applied to a solid-free drilling fluid, and thus it is guaranteed that the polymer still has the excellent viscosity-increasing performance (an apparent viscosity is 28 mPa·s or above) under the conditions of a high temperature (aging for 16 h at 180° C.) and a high calcium ion concentration (15000 mg/L) in the solid-free drilling fluid.

In the present disclosure, unless otherwise specially stated, the molar ratio of the structural units is calculated through a material feeding amount.

According to the present disclosure, the polymer has an intrinsic viscosity ranging from 1200 mL/g to 2600 mL/g, preferably, 1500 mL/g to 1900 mL/g.

According to the present disclosure, a viscosity average molecular weight of the polymer ranges from six million to 15 million, more preferably, 7.5 million to 10 million.

According to the present disclosure, the polymer is added into a solid-free drilling fluid base slurry with a Ca²⁺ concentration of 15000 mg/L at an addition amount of 0.7 wt %, and an apparent viscosity after aging for 16 h at 180° C. is 28 mPa·s or above, preferably, 36 mPa·s or above.

In the present disclosure, a formula of the solid-free drilling fluid base slurry is: adding 130.9 g of potassium formate, 1.75 g of anhydrous sodium carbonate and 3.5 g of sodium hydrogen carbonate into 350 mL of water, and then adding anhydrous calcium chloride till the Ca²⁺ concentration is 15000 mg/L.

In the present disclosure, the intrinsic viscosity is measured according to a method mentioned in GB12005.1-89; the viscosity average molecular weight is calculated with a formula M=802 [η]^{1.25} according to a method mentioned in GB12005.10-92, wherein M is the viscosity average molecular weight and [η] is the intrinsic viscosity; and the apparent viscosity is measured according to a method mentioned in GB/T 16783.1.

According to the present disclosure, an infrared spectrogram of the polymer has COO-conjugated system stretching vibration peaks around 1403 cm⁻¹ and 1573 cm⁻¹, and S═O characteristic vibration peaks around 614 cm⁻¹ and 1051 cm⁻¹, it can indicate that the polymer contains the structural unit represented by the formula (2) and the structural unit represented by the formula (3).

In the present disclosure, the infrared spectrogram of the polymer is measured by means of a Nicolet iS20 infrared spectrometer of Thermo Fisher Scientific Inc. in America.

According to a preferred implementation of the present disclosure, the polymer further includes a structural unit represented by a formula (4) below in addition to the structural unit represented by the formula (1), the structural unit represented by the formula (2) and the structural unit represented by the formula (3).

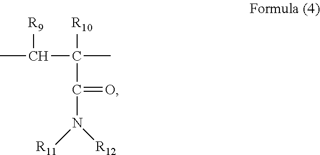

wherein R₉ and R₁₀ are each independently hydrogen or C1 to C10 linear or branched alkyl, preferably, hydrogen or C1 to C6 linear or branched alkyl, more preferably, hydrogen or C1 to C4 linear or branched alkyl, further preferably, hydrogen, methyl or ethyl; and R₁₁ and R₁₂ are each independently C1 to C6 linear or branched alkyl, more preferably, C1 to C4 linear or branched alkyl, further preferably, methyl or ethyl.

In a particularly preferred implementation of the present disclosure, in the structural unit represented by the formula (4), both R₉ and R₁₀ are hydrogen, and both R₁₁ and R₁₂ are methyl. At the moment, the structural unit represented by the formula (4) may be a structural unit from N,N-dimethylacrylamide.

An inventor of the present disclosure discovers that by introducing the structural unit represented by the formula (4) into the above polymer, hydrophobic association performance of the polymer can be further improved, and the structural unit represented by the formula (4) plays a synergistic effect with the structural unit represented by the formula (1), the structural unit represented by the formula (2) and the structural unit represented by the formula (3), so the temperature resistance and calcium resistance of the polymer can be further improved.

Besides, a content of the structural unit represented by the formula (4) may be determined according to a content of the structural unit represented by the formula (1) and may change within a large range. For example, a molar ratio of the structural unit represented by the formula (1) to the structural unit represented by the formula (4) may be 10-100:1, preferably, 40-80:1. By limiting the content of the structural unit represented by the formula (4) within the above range, the temperature resistance and calcium resistance of the polymer can be further improved.

Besides, according to another preferred implementation of the present disclosure, the polymer further includes a structural unit represented by a formula (5) below in addition to the structural unit represented by the formula (1), the structural unit represented by the formula (2), the structural unit represented by the formula (3) and the optional structural unit represented by the formula (4).

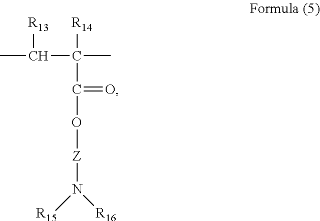

wherein R₁₃ and R₁₄ are each independently hydrogen or C1 to C10 linear or branched alkyl, preferably, hydrogen or C1 to C6 linear or branched alkyl, more preferably, hydrogen or C1 to C4 linear or branched alkyl, further preferably, hydrogen, methyl or ethyl; and R₁₅ and R₁₆ are each independently hydrogen or C1 to C6 linear or branched alkyl, more preferably, hydrogen or C1 to C4 linear or branched alkyl, further preferably, hydrogen, methyl or ethyl; and Z is C1 to C10 linear or branched alkylene, preferably, C1 to C6 linear or branched alkylene, more preferably, C1 to C4 linear or branched alkylene, further preferably, methylene or 1,2-ethylidene.

In a particularly preferred implementation of the present disclosure, in the structural unit represented by the formula (5), R₁₃ is hydrogen, R₁₄, R₁₅ and R₁₆ are methyl, and Z is 1,2-ethylidene. At the moment, the structural unit represented by the formula (5) may be a structural unit from dimethylaminoethyl methacrylate.

An inventor of the present disclosure discovers that by introducing the structural unit represented by the formula (5) into the above polymer, the structural unit represented by the formula (5) plays a synergistic effect with the structural unit represented by the formula (1), the structural unit represented by the formula (2), the structural unit represented by the formula (3) and the optional structural unit represented by the formula (4), so a molecular weight of the polymer is further improved, and a viscosity of the polymer can be further improved. By means of the synergistic effect among the structural units, the temperature resistance and calcium resistance of the polymer can be further improved when the polymer, as the tackifier, is applied to the solid-free drilling fluid.

Besides, a content of the structural unit represented by the formula (5) may be determined according to a content of the structural unit represented by the formula (1) and may change within a large range. For example, a molar ratio of the structural unit represented by the formula (1) to the structural unit represented by the formula (5) may be 10-100:1, preferably, 30-80:1. By limiting the content of the structural unit represented by the formula (5) within the above range, the temperature resistance and calcium resistance of the polymer can be further improved.

In addition, in a particularly preferred implementation of the present disclosure, the polymer includes the structural unit represented by the formula (1), the structural unit represented by the formula (2), the structural unit represented by the formula (3), the structural unit represented by the formula (4) and the structural unit represented by the formula (5). The polymer including the above structural units is added into a solid-free drilling fluid base slurry with a Ca²⁺ concentration of 15000 mg/L at an addition amount of 0.7 wt %, an apparent viscosity after aging for 16 h at 180° C. can reach up to 28 mPa·s or above, preferably, 36 mPa·s or above, and the polymer is quite suitable for serving as the tackifier for the solid-free drilling fluid.

In the present disclosure, the structural unit represented by the formula (1) can form an acrylamide skeleton structure, and by cooperating with the structural unit represented by the formula (2) including a sulfonic acid group and the structural unit represented by the formula (3) including-C(A₁COOH)(A₂COOH)(A₃COOH), the three structural units play a synergistic effect, and the temperature resistance and the calcium resistance of the obtained polymer can be remarkably improved.

Besides, by further introducing the structural unit represented by the formula (4) with a weak hydrophobic effect, the temperature resistance and salt resistance of the polymer can be further improved, and by introducing the structural unit represented by the formula (5), a chain extension effect can be achieved, so that the molecular weight of the polymer can be improved to the maximum degree, thereby improving the viscosity of the obtained polymer. Moreover, by means of the synergistic effect of the above five structural units, not only the respective features of each structural units can be exerted, but also the temperature resistance and the calcium resistance of the polymer can be improved to the maximum degree.

Besides, a preparation method for the polymer mentioned in the first aspect of the present disclosure is not specifically limited, for example, the method may be, subjecting monomers corresponding to the above structural units to a polymerization reaction in a solvent in the presence of an initiator under a polymerization reaction condition so as to obtain the polymer, and the specific preparation method can refer to a preparation method for a tackifier in a third aspect and is not described in detail here.

A second aspect of the present disclosure provides a tackifier, including an acrylamide skeleton structure, and the tackifier further includes a sulfonic acid group and —C(A₁COOH)(A₂COOH)(A₃COOH), wherein A₁, A₂ and A₃ are each independently a bond or C1 to C3 linear or branched alkylene, preferably, a bond, methylene or 1,2-ethylidene, more preferably, a bond or methylene.

In a particularly preferred implementation of the present disclosure, the tackifier includes the sulfonic acid group and —C(CH₂COOH)₂(COOH).

By introducing the sulfonic acid group and —C(A₁COOH)(A₂COOH)(A₃COOH), especially, introducing the sulfonic acid group and —C(CH₂COOH)₂(COOH) into the acrylamide skeleton structure, when the tackifier is added into a solid-free drilling fluid base slurry with a Ca²⁺ concentration of 15000 mg/L at an addition amount of 0.7 wt %, an apparent viscosity after aging for 16 h at 180° C. reaches up to 28 mPa·s or above, preferably, 36 mPa·s or above.

Besides, according to the second aspect of the present disclosure, a molar ratio of the sulfonic acid group to —COOH in the tackifier may be 3-20:1, preferably, 6-14:1, so that temperature resistance and calcium resistance of the tackifier can be further ensured.

Besides, according to the second aspect of the present disclosure, preferably, a content of —COOH in the tackifier is not less than 2 mol %, more preferably, not less than 3.2 mol %, further preferably, not less than 4 mol %. Accordingly, the temperature resistance and the calcium resistance of the tackifier can be further ensured.

In the present disclosure, the molar ratio of the sulfonic acid group to —COOH and the content of —COOH are calculated according to a material feeding ratio.

A third aspect of the present disclosure provides a preparation method for a tackifier, wherein the method includes: subjecting a monomer represented by a formula (A), a monomer represented by a formula (B) and a monomer represented by a formula (C) to a polymerization reaction in a solvent in the presence of an initiator under a polymerization reaction condition,

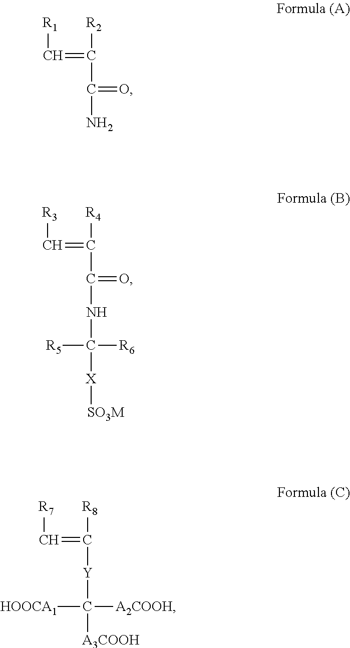

wherein R₁, R₂, R₃, R₄, R₅, R₆, R₇ and R₈ are each independently hydrogen or C1 to C10 linear or branched alkyl;
X is C1 to C10 linear or branched alkylene;
Y is

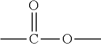

or C1 to C10 linear or branched alkylene;
M is hydrogen or an alkali metal; and
A₁, A₂ and A₃ are each independently a bond or C1 to C3 linear or branched alkylene.

An instance of C1 to C10 linear or branched alkyl, an instance of C1 to C10 linear or branched alkylene, an instance of the alkali metal and an instance of C1 to C3 linear or branched alkylene mentioned in the third aspect of the present disclosure may be the same as those of the first aspect of the present disclosure and are not described in detail here.

According to the present disclosure, in the formula (A), preferred substituent groups of R₁ and R₂ are the same as those of corresponding R₁ and R₂ in the formula (1) of the first aspect of the present disclosure, moreover, in a particularly preferred implementation of the present disclosure, in the formula (A), both R₁ and R₂ are hydrogen, namely, a monomer represented by the formula (A) is acrylamide.

According to the present disclosure, in the formula (B), preferred substituent groups of R₃, R₄, R₅, R₆, X and M are the same as those of corresponding R₃, R₄, R₅, R₆, X and M in the formula (2) of the first aspect of the present disclosure, and in a particularly preferred implementation of the present disclosure, in the formula (B), both R₃ and R₄ are hydrogen, both R₅ and R₆ are methyl, X is methylene, and M is hydrogen, namely, a monomer represented by the formula (B) is 2-acryloylamino-2-methyl propane sulfonic acid.

According to the present disclosure, in the formula (C), preferred substituent groups of R₇, R₈, Y, A₁, A₂ and A₃ are the same as those of corresponding R₇, R₈, Y, A₁, A₂ and A₃ in the formula (3) of the first aspect of the present disclosure, and in a particularly preferred implementation of the present disclosure, in the formula (C), both R₇ and R₈ are hydrogen, Y is

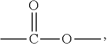

both A₁ and A₂ are methylene, and A₃ is a bond, namely, a monomer represented by the formula (C) is 2-acryloyloxy-1,2,3-tricarboxylicpropane.

In the present disclosure, a molar ratio of the monomer represented by the formula (A) to the monomer represented by the formula (B) to the monomer represented by the formula (C) may change within a large range, for example, 10-80:10-60:1, preferably, 30-50:20-40:1. By limiting the molar ratio of the above three monomers within the above range, temperature resistance and calcium resistance of the prepared polymer can be further improved when the polymer, as a tackifier, is applied to a solid-free drilling fluid.

Moreover, in the present disclosure, the preparation method for the tackifier can further include: a monomer represented by a formula (D) and/or a monomer represented by a formula (E) are/is subjected to a polymerization reaction in a solvent together with the monomer represented by the formula (A), the monomer represented by the formula (B) and the monomer represented by the formula (C)

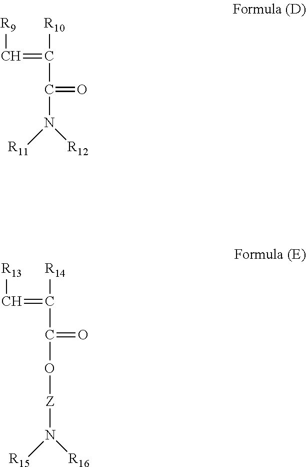

According to the present disclosure, in the formula (D), preferred substituent groups of R₉, R₁₀, R₁₁ and R₁₂ are the same as those of corresponding R₉, R₁₀, R₁₁ and R₁₂ in the formula (4) of the first aspect of the present disclosure, and in a particularly preferred implementation of the present disclosure, both R₉ and R₁₀ in the formula (D) are hydrogen, and both R₁₁ and R₁₂ are methyl, namely, the monomer represented by the formula (D) is N,N-dimethylacrylamide.

An inventor of the present disclosure discovers that by introducing the monomer represented by the formula (D) on the basis of the monomer represented by the formula (A), the monomer represented by the formula (B) and the monomer represented by the formula (C), hydrophobic association performance of the polymer can be further improved, and the monomer represented by the formula (D) can play a synergistic effect with the monomer represented by the formula (A), the monomer represented by the formula (B) and the monomer represented by the formula (C), so the temperature resistance and calcium resistance of the tackifier prepared thereby can be further improved.

Besides, an amount of the monomer represented by the formula (D) may be selected according to an amount of the monomer represented by the formula (A) and may change within a large range. For example, a molar ratio of the monomer represented by the formula (A) to the monomer represented by the formula (D) may be 10-100:1, preferably, 40-80:1. By limiting the content of the monomer represented by the formula (D) within the above range, the temperature resistance and calcium resistance of the tackifier can be further improved.

According to the present disclosure, in the formula (E), preferred substituent groups of R₁₃, R₁₄, R₁₅, R₁₆ and Z are the same as those of corresponding R₁₃, R₁₄, R₁₅, R₁₆ and Z in the formula (5) of the first aspect of the present disclosure, and in a particularly preferred implementation of the present disclosure, in the formula (E), R₁₃ is hydrogen, R₁₄, R₁₅ and R₁₆ are methyl, and Z is 1,2-ethylidene, namely, the methyl group represented by the formula (E) is dimethylaminoethyl methacrylate.

An inventor of the present disclosure discovers that by introducing the monomer represented by the formula (E) on the basis of the monomer represented by the formula (A), the monomer represented by the formula (B), the monomer represented by the formula (C) and the optional monomer represented by the formula (D), the monomer represented by the formula (E) can play a synergistic effect with the monomer represented by the formula (A), the monomer represented by the formula (B) and the monomer represented by the formula (C), so that a molecular weight of the tackifier is further improved, and a viscosity of the tackifier can be further improved. By means of the synergistic effect among the monomers, the temperature resistance and calcium resistance of the tackifier prepared thereby can be further improved when the tackifier is applied to the solid-free drilling fluid.

Besides, an amount of the monomer represented by the formula (E) may be selected according to an amount of the monomer represented by the formula (A) and may change within a large range. For example, a molar ratio of the monomer represented by the formula (A) to the monomer represented by the formula (E) may be 10-100:1, preferably, 30-80:1. By limiting the content of the monomer represented by the formula (E) within the above range, the temperature resistance and calcium resistance of the prepared polymer can be further improved.

By subjecting the monomer represented by the formula (D) or the monomer represented by the formula (E) to the polymerization reaction in the solvent together with the monomer represented by the formula (A), the monomer represented by the formula (B) and the monomer represented by the formula (C), especially subjecting the monomer represented by the formula (D) and the monomer represented by the formula (E) to the polymerization reaction in the solvent together with the monomer represented by the formula (A), the monomer represented by the formula (B) and the monomer represented by the formula (C), the temperature resistance and the calcium resistance of the prepared tackifier can be further improved, and the obtained tackifier can still maintain an excellent viscosity in a high-temperature and high-calcium environment.

Besides, in the present disclosure, the initiator may be various common initiators in the art capable of initiating the monomers to be subjected to the polymerization reaction, for example, the initiator may be selected from any one of an azo type initiator and a redox type initiator. Preferably, the initiator is a mixture of the azo type initiator and the redox type initiator.

In the present disclosure, the azo type initiator is not specifically limited, for example, may be at least one of azodiisobutyronitrile, azodiimidazoline propane dihydrochloride, 2,2′-azo(2-amidinopropane)dihydrochloride, 4,4′-azobis(4-cyanovaleric acid) and 2,2′-azodiisobutylamidine hydrochloride, preferably, at least one of 2,2′-azodiisobutylamidine hydrochloride, 2,2′-azo(2-amidinopropane)dihydrochloride and azodiimidazoline propane dihydrochloride.

In the present disclosure, the redox type initiator is not specifically limited and includes an oxidizing agent and a reducing agent. The oxidizing agent may be, for example, at least one of ammonium persulfate, potassium persulfate, sodium persulfate and hydrogen peroxide, preferably, the ammonium persulfate and/or the potassium persulfate.

Besides, in the present disclosure, the reducing agent may be selected from at least one of an inorganic reducing agent and an organic reducing agent.

The inorganic reducing agent may be, for example, at least one of sodium hydrogen sulfite, sodium sulfite, ferrous sulfate, sodium thiosulfate and urea, preferably, the sodium hydrogen sulfite and/or the sodium sulfite.

The organic reducing agent may be, for example, at least one of N,N-dimethylethanolamine, N,N-dimethylpropanolamine, N,N-dimethylpiperazine, N,N′-dimethylpiperazine, tetramethylurea, N,N-dimethylurea, N,N,N′,N′-tetramethylethylenediamine, N,N′-dimethylethylenediamine, N,N′-dimethyl-1,3-propane diamine, 3-methylaminopropylamine and N,N-dimethylethylenediamine, preferably, the N,N′-dimethyl-1,3-propane diamine or the N,N,N′,N′-tetramethylethylenediamine, more preferably, the N,N,N′,N′-tetramethylethylenediamine.

An inventor of the present disclosure discovers in the research that when the reducing agent adopts a mixture of the inorganic reducing agent and the organic reducing agent, not only are monomers fully converted on the premise of ensuring a high molecular weight of a polymer to the maximum degree, but also the temperature resistance and the calcium resistance of the tackifier obtained through polymerization can be further improved. Therefore, in the present disclosure, preferably, the reducing agent is the mixture of the inorganic reducing agent and the organic reducing agent.

Besides, in the present disclosure, an amount of the initiator is not specifically limited, which may be determined according to contents of the monomers participating in the polymerization reaction as long as the polymerization reaction can be initiated. For example, if a total weight of polymerization monomers (a total weight of the monomer represented by the formula (A), the monomer represented by the formula (B), the monomer represented by the formula (C), the optional monomer represented by the formula (D) and the optional monomer represented by the formula (E)) is 100 weight parts, a total amount of the initiator may range from 0.1 weight part to 1 weight part, preferably, 0.3 weight part to 0.6 weight part. By limiting the use amount of the initiator within the above range, not only the polymerization reaction can be performed more smoothly, but also the polymerization reaction can be regulated, so that it is further guaranteed that the prepared tackifier has good temperature resistance and calcium resistance.

In the present disclosure, when the initiator is a mixture of the azo type initiator and the redox type initiator, the redox type initiator may be used in an amount ranging from 30 wt % to 90 wt % of a total amount of the initiator, preferably, 60 wt % to 80 wt %, and a balance is the azo type initiator.

In the present disclosure, in the redox type initiator, the reducing agent can be used in an amount ranging from 40 wt % to 80 wt % of a total use amount of the oxidizing agent and the reducing agent, preferably, 50 wt % to 70 wt %, and a balance is the oxidizing agent.

Besides, in the present disclosure, when the reducing agent is a mixture of the inorganic reducing agent and the organic reducing agent, the organic reducing agent can be used in an amount ranging from 30 wt % to 90 wt % of a total amount of the reducing agent, preferably, 60 wt % to 80 wt %, and a balance is the inorganic reducing agent. Therefore, not only the smooth polymerization reaction can be further promoted, but also the temperature resistance and the calcium resistance of the prepared tackifier can be further improved.

Besides, according to the present disclosure, the solvent can be a conventional solvent for the polymerization reaction in the art and is not specifically limited. For example, the solvent may be water, preferably, deionized water.

Besides, an amount of the solvent is not specifically limited and may be determined according to a total weight of the polymerization monomers (the monomer represented by the formula (A), the monomer represented by the formula (B), the monomer represented by the formula (C), the optional monomer represented by the formula (D) and the optional monomer represented by the formula (E)), for example, the solvent may be used in an amount ranging from two times to six times of the total weight of the polymerization monomers, preferably, three times to five times. By limiting the amount of the solvent within the above range, not only smoother polymerization reaction can be guaranteed, but also it can be guaranteed that the prepared tackifier has good temperature resistance and calcium resistance.

Besides, in the present disclosure, the monomers, the initiator and the solvent can be added into a reaction device at the same time and stirred and mixed uniformly; or the monomers and the solvent can be mixed first, and then the initiator is added for initiating a reaction; or the initiator and the solvent can be mixed first, and then the monomers are added.

In the present disclosure, preferably, the monomers and the solvent are mixed first, and then the initiator is added for initiating the reaction.

According to the third aspect of the present disclosure, the polymerization reaction condition is not specifically limited as long as the monomers are caused to be polymerized. Preferably, the polymerization reaction condition includes: a temperature ranging from −10° C. to 15° C., preferably, −10° C. to 0° C., more preferably, −10° C. to −5° C.; and a time ranging from 1 hour to 20 hours, preferably, 5 hours to 10 hours, more preferably, 8 hours to 10 hours. Thus, rapid and complete polymerization reaction can be further guaranteed.

Besides, in the present disclosure, the polymerization reaction can be performed under a condition of a pH ranging from 4 to 12, preferably, a pH ranging from 5 to 10, more preferably, a pH ranging from 6 to 9.

Besides, the polymerization reaction is performed preferably in the presence of inert gas, and the inert gas may be, for example, nitrogen gas, argon gas, helium gas and the like and is not specifically limited.

In the present disclosure, the preparation method for the tackifier further includes: after the polymerization reaction is completed, a product obtained after the polymerization reaction is pelleted, then mixed and kneaded with an inorganic base to be hydrolyzed to obtain a hydrolyzed product, and then the obtained hydrolyzed product is pelleted, dried and crushed.

In the present disclosure, the inorganic base is not specifically limited, for example, may be one or more of sodium hydroxide, potassium hydroxide and sodium carbonate, preferably, sodium hydroxide and/or potassium hydroxide.

Besides, in the present disclosure, an amount of the inorganic base is not specifically limited, for example, if the total weight of the polymerization monomers (the total weight of the monomer represented by the formula (A), the monomer represented by the formula (B), the monomer represented by the formula (C), the optional monomer represented by the formula (D) and the optional monomer represented by the formula (E)) is 100 weight parts, the inorganic base can be used in an amount ranging from 5 weight parts to 30 weight parts, preferably, 20 weight parts to 30 weight parts.

Besides, in the present disclosure, conditions of a hydrolysis temperature and time are not specifically limited, for example, the hydrolysis temperature may range from 40° C. to 100° C., preferably, 60° C. to 90° C., more preferably, 80° C. to 85° C.; and the hydrolysis time may range from 0.5 h to 6 h, preferably, 1 h to 4 h, more preferably, 2 h to 3 h.

In the present disclosure, in order to obtain the tackifier with uniform particles, further, the preparation method further includes screening the crushed product.

In the present disclosure, operation methods of pelleting, drying, crushing, screening and the like are not specifically limited and may adopt conventional or known methods in the art, which is not described in detail here.

In an infrared spectrogram of a polymer prepared through the method according to the third aspect of the present disclosure, a C═C stretching vibration peak is not found around 1653 cm⁻¹, and a double-bond C—H stretching vibration peak is not found around 3017 cm⁻¹, which indicates that the polymerization reaction is completely performed, and there is no unreacted residual monomer.

Besides, the tackifier prepared by the third aspect of the present disclosure has the performances of the polymer of the first aspect of the present disclosure and the tackifier of the second aspect of the present disclosure, which is not described in detail here.

A fourth aspect of the present disclosure provides a drilling fluid, including the polymer mentioned in the first aspect or the tackifier mentioned in the second aspect. And preferably, the drilling fluid is a solid-free drilling fluid, that is, the drilling fluid does not include clay and the weighting agent.

According to the fourth aspect of the present disclosure, the polymer or the tackifier in the drilling fluid has a content ranging from 0.1 wt % to 3 wt %, preferably, 0.5 wt % to 1.5 wt %, so that cuttings suspension and carrying performance of the drilling fluid can be further improved.

Besides, the drilling fluid of the present disclosure may have a density ranging from 1.01 g/cm³ to 2.30 g/cm³, preferably, 1.10 g/cm³ to 1.80 g/cm³.

In order to better describe the present disclosure, functions and effects of the present disclosure are further described below with reference to examples and comparative examples, but the scope of the present disclosure is not only limited to these examples.

In the following examples and the comparative examples, unless otherwise stated, adopted materials are commercially available conventional materials.

In the following examples and the comparative examples, the viscosity average molecular weight is measured according to the method regulated in GB12005.10-92, that is, the viscosity average molecular weight of the polymer is calculated by using a formula M=802 [η]^{1.25}, where [η] is the intrinsic viscosity which is measured according to the method mentioned in GB12005.1-89.

The apparent viscosity is measured according to the method regulated in GB/T 16783.1.

2-acryloyloxy-1,2,3-tricarboxylicpropane used in the following examples was prepared according to the following method:
1) 19.2 g of citric acid and 80 mL of N,N′-dimethylformamide (DMF) were added into a single-neck flask and then stirred till citric acid was completely dissolved; and
2) 20 mL of a DMF solution of acryloyl chloride (acryloyl chloride had a content of 0.45 g/mL) was slowly dropwise added with a pressure-equalizing dropping funnel, after a reaction was performed for 12 h, reduced pressure distillation was performed for removing DMF to obtain a product, and it was known to be 2-acryloyloxy-1,2,3-tricarboxylicpropane through nuclear magnetic resonance analysis.

### Example 1

1) 2840 kg (40 kmol) of acrylamide, 6210 kg (30 kmol) of 2-acryloylamino-2-methyl propane sulfonic acid, 246 kg (1 kmol) of 2-acryloyloxy-1,2,3-tricarboxylicpropane, 66 kg (0.67 kmol) of N,N-dimethylacrylamide, 125.6 kg (0.8 kmol) of dimethylaminoethyl methacrylate and deionized water (a weight of the deionized water was 4 times of a total weight of the monomers) were added into a batching kettle, in a stirring state, a temperature of a solution was controlled at −7° C. with freezing brine water, sodium hydroxide was added to regulate a pH to 7, and a mixed monomer solution was obtained;
2) the mixed monomer solution obtained in step 1) was pumped into a polymerization kettle, high-purity nitrogen gas was fed for removing oxygen for 0.5 h, then 14.12 kg of N,N,N′,N′-tetramethylethylenediamine, 6.04 kg of sodium hydrogen sulfite, 13.44 kg of ammonium persulfate and 14.4 kg of 2,2′-azo(2-amidinopropane)dihydrochloride were added in sequence, and a polymerization reaction was performed under still standing at −7° C. for 10 h to obtain polymer gel; and
3) a reactor bottom ball valve was opened, the polymer gel obtained in step 2) was extruded with 0.3 MPa of compressed air, the polymer gel was pelleted into 4 mm to 6 mm gel particles through a pelletizer, then 1500 kg of gel particles were kneaded and in contact with 400 kg of sodium hydroxide particles, hydrolysis was performed at a temperature of 85° C. for 2 h, after secondary pelleting, drying was performed under a 75° C. hot air condition for 2 h, and then crushing and screening were performed till 20 meshes to 80 meshes were reached to obtain a polymer A1.

An intrinsic viscosity and a viscosity average molecular weight of the polymer A1 are shown in table 1.

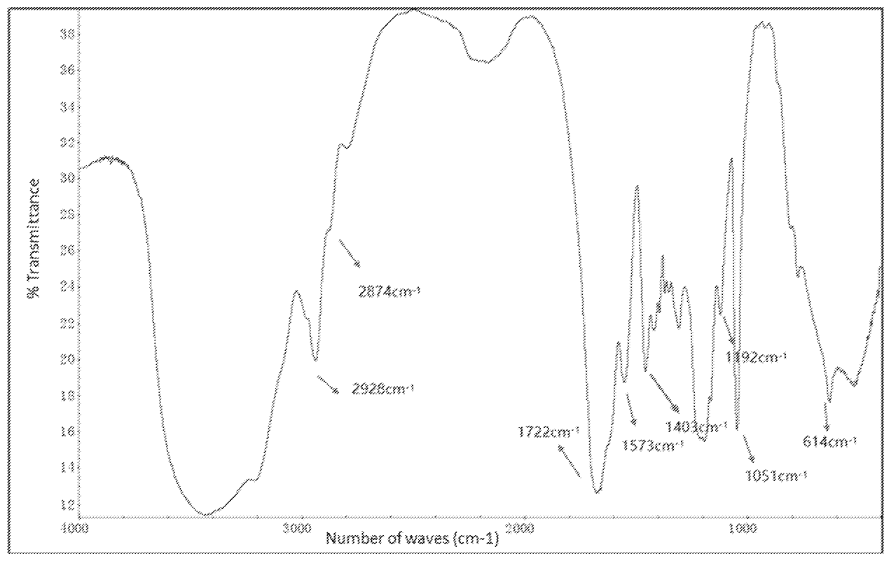

An infrared spectrogram of the polymer A1 is shown in FIG. 1, it can be known from FIG. 1 that the polymer A1 has COO-conjugated system stretching vibration peaks around 1403 cm⁻¹ and 1573 cm⁻¹, S═O characteristic vibration peaks around 614 cm⁻¹ and 1051 cm⁻¹, and a characteristic vibration peak of tertiary amine C—N around 1192 cm⁻¹, it indicates that the monomers 2-acryloylamino-2-methyl propane sulfonic acid, 2-acryloyloxy-1,2,3-tricarboxylicpropane and dimethylaminoethyl methacrylate are polymerized successfully.

Besides, in the infrared spectrogram of the polymer A1, a C═C stretching vibration peak is not found around 1653 cm⁻¹, and a double-bond C—H stretching vibration peak is not found around 3017 cm⁻¹. It indicates that the polymerization reaction is complete, and there is no unreacted residual monomer.

### Example 2

1) 3550 kg (50 kmol) of acrylamide, 4140 kg (20 kmol) of 2-acryloylamino-2-methyl propane sulfonic acid, 246 kg (1 kmol) of 2-acryloyloxy-1,2,3-tricarboxylicpropane, 61.88 kg (0.625 kmol) of N,N-dimethylacrylamide, 98.12 kg (0.625 kmol) of dimethylaminoethyl methacrylate and deionized water (a weight of the deionized water was 3 times of a total weight of the monomers) were added into a batching kettle, in a stirring state, a temperature of a solution was controlled at −5° C. with freezing brine water, sodium hydroxide was added to regulate a pH to 8, and a mixed monomer solution was obtained;
2) the mixed monomer solution obtained in step 1) was pumped into a polymerization kettle, high-purity nitrogen gas was fed for removing oxygen for 0.5 h, then 12.2 kg of N,N,N′,N′-tetramethylethylenediamine, 8.2 kg of sodium hydrogen sulfite, 8.7 kg of ammonium persulfate and 19.4 kg of 2,2′-azo(2-amidinopropane)dihydrochloride were added in sequence, and a polymerization reaction was performed under still standing at −5° C. for 9 h to obtain polymer gel; and
3) a reactor bottom ball valve was opened, the polymer gel obtained in step 2) was extruded with 0.3 MPa of compressed air, the polymer gel was pelleted into 4 mm to 6 mm gel particles through a pelletizer, then 1500 kg of gel particles were kneaded and in contact with 400 kg of sodium hydroxide particles, hydrolysis was performed at a temperature of 85° C. for 2 h, after secondary pelleting, drying was performed under a 75° C. hot air condition for 2 h, and then crushing and screening were performed till 20 meshes to 80 meshes were reached to obtain a polymer A2.

An intrinsic viscosity and a viscosity average molecular weight of the polymer A2 are shown in table 1.

An infrared spectrogram of the polymer A2 is similar to that of the polymer A1.

### Example 3

1) 2130 kg (30 kmol) of acrylamide, 8280 kg (40 kmol) of 2-acryloylamino-2-methyl propane sulfonic acid, 246 kg (1 kmol) of 2-acryloyloxy-1,2,3-tricarboxylicpropane, 74.25 kg (0.75 kmol) of N,N-dimethylacrylamide, 157 kg (1 kmol) of dimethylaminoethyl methacrylate and deionized water (a weight of the deionized water was 5 times of a total weight of the monomers) were added into a batching kettle, in a stirring state, a temperature of a solution was controlled at −10° C. with freezing brine water, sodium hydroxide was added to regulate a pH to 9, and a mixed monomer solution was obtained;
2) the mixed monomer solution obtained in step 1) was pumped into a polymerization kettle, high-purity nitrogen gas was fed for removing oxygen for 0.5 h, then 10.4 kg of N,N,N′,N′-tetramethylethylenediamine, 2.6 kg of sodium hydrogen sulfite, 13 kg of ammonium persulfate and 6.5 kg of 2,2′-azo(2-amidinopropane)dihydrochloride were added in sequence, and a polymerization reaction was performed under still standing at −10° C. for 8 h to obtain polymer gel; and
3) a reactor bottom ball valve was opened, the polymer gel obtained in step 2) was extruded with 0.3 MPa of compressed air, the polymer gel was pelleted into 4 mm to 6 mm gel particles through a pelletizer, then 1500 kg of gel particles were kneaded and in contact with 400 kg of sodium hydroxide particles, hydrolysis was performed at a temperature of 85° C. for 2 h, after secondary pelleting, drying was performed under a 75° C. hot air condition for 2 h, and then crushing and screening were performed till 20 meshes to 80 meshes are reached to obtain a polymer A3.

An intrinsic viscosity and a viscosity average molecular weight of the polymer A3 are shown in table 1.

An infrared spectrogram of the polymer A3 is similar to that of the polymer A1.

### Example 4

Example 4 was performed according to the method of Example 1, but with following differences.

In step 1), 5680 kg (80 kmol) of acrylamide, 2070 kg (10 kmol) of 2-acryloylamino-2-methyl propane sulfonic acid, 246 kg (1 kmol) of 2-acryloyloxy-1,2,3-tricarboxylicpropane, 79.2 kg (0.8 kmol) of N,N-dimethylacrylamide, 125.6 kg (0.8 kmol) of dimethylaminoethyl methacrylate and deionized water (a weight of the deionized water was 4 times of a total weight of the monomers) were added into a batching kettle; and
in step 2), 12 kg of N,N,N′,N′-tetramethylethylenediamine, 5.2 kg of sodium hydrogen sulfite, 11.5 kg of ammonium persulfate and 12.3 kg of 2,2′-azo(2-amidinopropane)dihydrochloride were added in sequence.

A polymer A4 was obtained.

An intrinsic viscosity and a viscosity average molecular weight of the polymer A4 are shown in table 1.

An infrared spectrogram of the polymer A4 is similar to that of the polymer A1.

### Example 5

Example 5 was performed according to the method of Example 1, but with following differences.

In step 1),

Dimethylaminoethyl methacrylate was not added, and a polymer A5 was obtained.

An intrinsic viscosity and a viscosity average molecular weight of the polymer A5 are shown in table 1.

In an infrared spectrogram of the polymer A5, COO-conjugated system stretching vibration peaks exist around 1403 cm⁻¹ and 1573 cm⁻¹, and S═O characteristic vibration peaks exist around 614 cm⁻¹ and 1051 cm⁻¹, it indicates that the monomers 2-acryloylamino-2-methyl propane sulfonic acid and 2-acryloyloxy-1,2,3-tricarboxylicpropane are polymerized successfully.

Besides, in the infrared spectrogram of the polymer A5, a C═C stretching vibration peak is not found around 1653 cm⁻¹, and a double-bond C—H stretching vibration peak is not found around 3017 cm⁻¹. It indicates that the polymerization reaction is complete, and there is no unreacted residual monomer.

### Example 6

Example 6 was performed according to the method of Example 1, but with following differences.

In step 1),

N,N-dimethylacrylamide was not added, and a polymer A6 was obtained.

An intrinsic viscosity and a viscosity average molecular weight of the polymer A6 are shown in table 1.

In an infrared spectrogram of the polymer A6, COO-conjugated system stretching vibration peaks exist around 1403 cm⁻¹ and 1573 cm⁻¹, S═O characteristic vibration peaks exist around 614 cm⁻¹ and 1051 cm⁻¹, and a characteristic vibration peak of tertiary amine C—N exists around 1192 cm⁻¹, it indicates that the monomers 2-acryloylamino-2-methyl propane sulfonic acid, 2-acryloyloxy-1,2,3-tricarboxylicpropane and dimethylaminoethyl methacrylate are polymerized successfully.

Besides, in the infrared spectrogram of the polymer A6, a C═C stretching vibration peak is not found around 1653 cm⁻¹, and a double-bond C—H stretching vibration peak is not found around 3017 cm⁻¹. It indicates that the polymerization reaction is complete, and there is no unreacted residual monomer.

### Example 7

Example 7 was performed according to the method of Example 1, but with following differences. In step 1),

N,N-dimethylacrylamide and dimethylaminoethyl methacrylate were not added, and a polymer A7 was obtained.

An intrinsic viscosity and a viscosity average molecular weight of the polymer A7 are shown in table 1.

In an infrared spectrogram of the polymer A7, COO-conjugated system stretching vibration peaks exist around 1403 cm⁻¹ and 1573 cm⁻¹, and S═O characteristic vibration peaks exist around 614 cm⁻¹ and 1051 cm⁻¹, it indicates that the monomers 2-acryloylamino-2-methyl propane sulfonic acid and 2-acryloyloxy-1,2,3-tricarboxylicpropane are polymerized successfully.

Besides, in the infrared spectrogram of the polymer A7, a C═C stretching vibration peak is not found around 1653 cm⁻¹, and a double-bond C—H stretching vibration peak is not found around 3017 cm⁻¹. It indicates that the polymerization reaction is complete, and there is no unreacted residual monomer.

### Example 8

Example 8 was performed according to the method of Example 1, but with following differences.

In step 2),

N,N,N′,N′-tetramethylethylenediamine was replaced with sodium hydrogen sulfite with the same weight, and a polymer A8 was obtained.

An intrinsic viscosity and a viscosity average molecular weight of the polymer A8 are shown in table 1.

An infrared spectrogram of the polymer A8 is similar to that of the polymer A1.

### Example 9

Example 9 was performed according to the method of Example 1, but with following differences.

In step 2),

Sodium hydrogen sulfite was replaced with N,N,N′,N′-tetramethylethylenediamine with the same weight, and a polymer A9 was obtained.

An intrinsic viscosity and a viscosity average molecular weight of the polymer A9 are shown in table 1.

An infrared spectrogram of the polymer A9 is similar to that of the polymer A1.

### Comparative Example 1

Comparative Example 1 was performed according to the method of Example 1, but with following differences.

In step 1),

2-acryloyloxy-1,2,3-tricarboxylicpropane was not added, and a polymer D1 was obtained.

An intrinsic viscosity and a viscosity average molecular weight of the polymer D1 are shown in table 1.

### Comparative Example 2

Comparative Example 2 was performed according to the method of Example 1, but with following differences.

In step 1),

2-acryloyloxy-1,2,3-tricarboxylicpropane was replaced with methacrylic acid with the same molar quantity of carboxyl, and a polymer D2 was obtained.

An intrinsic viscosity and a viscosity average molecular weight of the polymer D2 are shown in table 1.

### Comparative Example 3

A polymer tackifier HE® 150 manufactured by Chevron Phillips Chemical was used as a polymer D3.

An intrinsic viscosity and a viscosity average molecular weight of the polymer D3 are shown in table 1.

### Comparative Example 4

Comparative Example 4 was performed according to the method of Example 1, but with following differences.

In step 1),

Five monomers in Example 1 were replaced with 2-acryloyloxy-1,2,3-tricarboxylicpropane with the same weight as a total weight of the five monomers, and a polymer D4 was obtained.

An intrinsic viscosity and a viscosity average molecular weight of the polymer D4 are shown in table 1.

The polymer D4 was mixed with the polymer D1 according to a weight ratio being 1:1 to obtain a polymer D5.

TABLE 1
Results of intrinsic viscosity and viscosity
average molecular weight of the polymers.

| Polymer | Intrinsic viscosity (mL/g) | Viscosity average molecular |
|---|---|---|
| A1 | 1679 | 862 |
| A2 | 1761 | 915 |
| A3 | 1606 | 816 |
| A4 | 2406 | 1352 |
| A5 | 1696 | 873 |
| A6 | 1710 | 882 |
| A7 | 1741 | 902 |
| A8 | 1552 | 781 |
| A9 | 1524 | 764 |
| D1 | 1807 | 945 |
| D2 | 1687 | 867 |
| D3 | 1512 | 756 |
| D4 | 482 | 181 |

### Test Example 1

### Test for Apparent Viscosity

1) 130.9 g of potassium formate was added into 350 mL of deionized water to obtain a potassium formate aqueous solution;
2) 1.75 g of anhydrous sodium carbonate and 3.5 g of sodium hydrogen carbonate were added into the potassium formate aqueous solution obtained in step 1), after uniform stirring, curing was performed for 24 h under airtight condition at a temperature of 25° C.±3° C., then anhydrous calcium chloride was added thereto and dissolved by stirring, so that the concentration of Ca²⁺ was 15000 mg/L, and a solid-free drilling fluid base slurry was obtained; and
3) 350 g of the solid-free drilling fluid base slurry obtained in step 2) was taken, 2.45 g of a polymer sample was added into the slurry slowly under stirring, after stirring and dissolving with an electric stirrer for 30 min, the density of the obtained drilling fluid was measured to be 1.15 g/cm³. Then constant-temperature rolling was performed for 16 h at 180° C. in a high-temperature roller oven, after cooling, stirring was performed for 5 min, a corresponding apparent viscosity AV was measured, and results are shown in Table 2.

TABLE 2
Results of apparent viscosity.

| Polymer | AV/mPa · s |
|---|---|
| A1 | 38 |
| A2 | 37 |
| A3 | 36 |
| A4 | 28 |
| A5 | 32 |
| A6 | 31 |
| A7 | 29 |
| A8 | 33 |
| A9 | 32 |
| D1 | 21 |
| D2 | 23 |
| D3 | 17 |
| D4 | 4 |
| D5 | 12 |

It can be seen from results of Table 2 that when the polymer of the present disclosure is added into a calcium-containing solid-free drilling fluid as a tackifier, the apparent viscosity can reach up to 38 mPa·s after high-temperature aging 16 h at 180° C., which is far superior than the apparent viscosity of a current foreign similar product HER 150 (Comparative Example 3), and it indicates that the polymer of the present disclosure has better viscosity increasing performance, temperature resistance and calcium resistance and can effectively improve a rheological property of the solid-free drilling fluid in a high-temperature and high-calcium environment.

From the test results of the polymers A1-A3 and A4, it can be seen that the temperature resistance and the calcium resistance of the obtained polymers can be further improved by controlling the amount of each monomer within the preferred range of the present disclosure.

From the test results of the polymers A1 and A5 to A7, it can be seen that the temperature resistance and the calcium resistance of the obtained polymers can be further improved by further adding the monomer represented by the formula (D) and/or the monomer represented by the formula (E) on the basis of the monomer represented by the formula (A), the monomer represented by the formula (B), the monomer represented by the formula (C).

Besides, it can be seen from test results of the polymers A1, A8 and A9 that the temperature resistance and the calcium resistance of the prepared polymers can be further improved when the polymer is prepared by using the initiator containing both the inorganic reducing agent and the organic reducing agent.

The preferable implementations of the present disclosure are described in detail above, but the present disclosure is not limited to this. Within the scope of the technical concept of the present disclosure, various simple variations can be made to the technical solutions of the present disclosure, which include combining various technical features in any other appropriate mode, and these simple variations and combinations are to also be regarded as contents disclosed by the present disclosure and fall within the protection scope of the present disclosure.

1. A polymer, comprising a structural unit represented by a formula (1), a structural unit represented by a formula (2) and a structural unit represented by a formula (3), 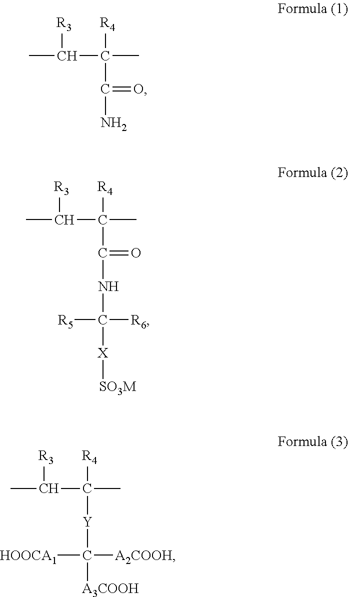
wherein R₁, R₂, R₃, R₄, R₅, R₆, R₇ and R₈ are each independently hydrogen or C1 to C10 linear or branched alkyl;
X is C1 to C10 linear or branched alkylene;
Y is 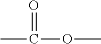
or C1 to C10 linear or branched alkylene;
M is hydrogen or an alkali metal; and
A₁, A₂ and A₃ are each independently a bond or C1 to C3 linear or branched alkylene.

2. The polymer according to claim 1, wherein R₁, R₂, R₃, R₄, R₅, R₆, R₇ and R₈ are each independently hydrogen or C1 to C4 linear or branched alkyl;
X is C1 to C3 linear or branched alkylene;
Y is 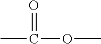
or C1 to C3 linear or branched alkylene;
M is hydrogen or sodium; and
A₁, A₂ and A₃ are each independently a bond, methylene or 1,2-ethylidene.

3. The polymer according to claim 1, wherein a molar ratio of the structural unit represented by the formula (1) to the structural unit represented by the formula (2) to the structural unit represented by the formula (3) is 10-80:10-60:1.

4. The polymer according to claim 1, wherein the polymer further comprises a structural unit represented by a formula (4) and/or a structural unit represented by a formula (5), 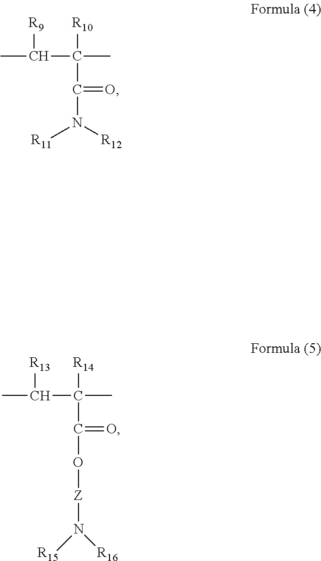
wherein R₉, R₁₀, R₁₃ and R₁₄ are each independently hydrogen or C1 to C10 linear or branched alkyl;
R₁₁ and R₁₂ are each independently C1 to C6 linear or branched alkyl;
R₁₅ and R₁₆ are each independently hydrogen or C1 to C6 linear or branched alkyl;
Z is C1 to C10 linear or branched alkylene;
a molar ratio of the structural unit represented by the formula (1) to the structural unit represented by the formula (4) is 10-100:1; and
a molar ratio of the structural unit represented by the formula (1) to the structural unit represented by the formula (5) is 10-100:1.

5. The polymer according to claim 1, wherein the polymer has an intrinsic viscosity ranging from 1200 mL/g to 2600 mL/g; and
the polymer has a viscosity average molecular weight ranging from 6 million to 15 million.

6. The polymer according to claim 1, wherein the polymer is added into a solid-free drilling fluid base slurry with a Ca²⁺ concentration of 15000 mg/L at an addition amount of 0.7 wt %, and an apparent viscosity after aging for 16 h at 180° C. is 28 mPa·s or above.

7. The polymer according to claim 1, wherein an infrared spectrogram of the polymer has COO-conjugated system stretching vibration peaks around 1403 cm⁻¹ and 1573 cm⁻¹, and S═O characteristic vibration peaks around 614 cm⁻¹ and 1051 cm⁻¹.

8. A tackifier, comprising an acrylamide skeleton structure, wherein the tackifier further comprises a sulfonic acid group and —C(A₁COOH)(A₂COOH)(A₃COOH), wherein A₁, A₂ and A₃ are each independently a bond or C1 to C3 alkylene, the tackifier is added into a solid-free drilling fluid base slurry with a Ca²⁺ concentration of 15000 mg/L at an addition amount of 0.7 wt %, and an apparent viscosity after aging for 16 h at 180° C. is 28 mPa·s or above.

9. The tackifier according to claim 8, wherein a molar ratio of the sulfonic acid group to —COOH is 3-20:1, and
a content of —COOH is not less than 2 mol %.

10. A preparation method for a tackifier, comprising: subjecting a monomer represented by a formula (A), a monomer represented by a formula (B) and a monomer represented by a formula (C) to a polymerization reaction in a solvent in the presence of an initiator under a polymerization reaction condition, 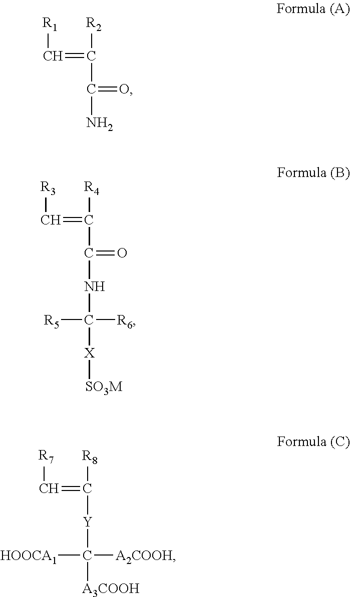
wherein R₁, R₂, R₃, R₄, R₅, R₆, R₇ and R₈ are each independently hydrogen or C1 to C10 linear or branched alkyl;
X is C1 to C10 linear or branched alkylene;
Y is 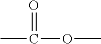
or C1 to C10 linear or branched alkylene;
M is hydrogen or an alkali metal; and
A₁, A₂ and A₃ are each independently a bond or C1 to C3 linear or branched alkylene.

11. The method according to claim 10, wherein R₁, R₂, R₃, R₄, R₅, R₆, R₇ and R₈ are each independently hydrogen or C1 to C4 linear or branched alkyl;
X is C to C3 linear or branched alkylene;
Y is 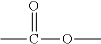
or C1 to C3 linear or branched alkylene;
M is hydrogen or sodium; and
A₁, A₂ and A₃ are each independently a bond, methylene or 1,2-ethylidene.

12. The method according to claim 10, wherein a molar ratio of the monomer represented by the formula (A) to the monomer represented by the formula (B) to the monomer represented by the formula (C) is 10-80:10-60:1.

13. The method according to claim 10, further comprising: subjecting a monomer represented by a formula (D) and/or a monomer represented by a formula (E), the monomer represented by the formula (A), the monomer represented by the formula (B) and the monomer represented by the formula (C) to a polymerization reaction in a solvent, 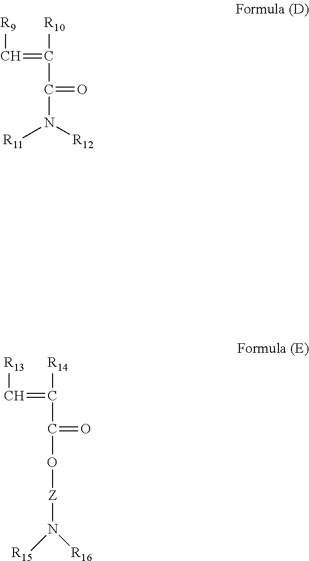
wherein R₉, R₁₀, R₁₃ and R₁₄ are each independently hydrogen or C1 to C10 linear or branched alkyl;
R₁₁ and R₁₂ are each independently C1 to C6 linear or branched alkyl;
R₁₅ and R₁₆ are each independently hydrogen or C1 to C6 linear or branched alkyl;
Z is C1 to C10 linear or branched alkylene;
a molar ratio of the monomer represented by the formula (A) to the monomer represented by the formula (D) is 10-100:1; and
a molar ratio of the monomer represented by the formula (A) to the monomer represented by the formula (E) is 10-100:1.

14. The method according to claim 10, wherein the initiator comprises a redox initiator.

15. The method according to claim 10, wherein the polymerization reaction condition comprises: a temperature ranging from −10° C. to 15° C.; a time ranging from 1 h to 20 h; and a pH ranging from 4 to 12.

16.-17. (canceled)

18. The polymer according to claim 2, wherein R₁, R₂, R₃, R₄, R₇ and R₈ are each independently hydrogen;
R₅ and R₆ are each independently methyl;
X is methylene;
Y is 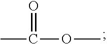
M is hydrogen; and
both A₁ and A₂ are methylene, and A₃ is a bond.

19. The polymer according to claim 4, wherein R₉, R₁₀ and R₁₃ are each independently hydrogen;
R₁₁, R₁₂, R₁₄, R₁₅ and R₁₆ are each independently methyl;
Z is 1,2-ethylidene;
a molar ratio of the structural unit represented by the formula (1) to the structural unit represented by the formula (4) is 40-80:1; and
a molar ratio of the structural unit represented by the formula (1) to the structural unit represented by the formula (5) is 30-80:1.

20. The method according to claim 11, wherein R₁, R₂, R₃, R₄, R₇ and R₈ are each independently hydrogen;
R₅ and R₆ are each independently methyl;
X is methylene;
Y is 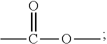
M is hydrogen; and
both A₁ and A₂ are methylene, and A₃ is a bond.

21. The method according to claim 13, wherein R₉, R₁₀ and R₁₃ are each independently hydrogen;
R₁₁, R₁₂, R₁₄, R₁₅ and R₁₆ are each independently methyl;
Z is 1,2-ethylidene;
a molar ratio of the monomer represented by the formula (A) to the monomer represented by the formula (D) is 40-80:1; and
a molar ratio of the monomer represented by the formula (A) to the monomer represented by the formula (E) is 30-80:1.

22. The method according to claim 14, wherein a reducing agent in the redox initiator is a mixture of an inorganic reducing agent and an organic reducing agent;
in the mixture of the inorganic reducing agent and the organic reducing agent, the organic reducing agent is used in an amount ranging from 30 wt % to 90 wt %.
